(19) United States
(12) Patent Application Publication
(10) Pub. No.: US 2018/0234576 A1
(43) Pub. Date: Aug. 16, 2018

(54) IMAGE READING APPARATUS AND IMAGE FORMING APPARATUS

(71) Applicant: CANON KABUSHIKI KAISHA, Tokyo (JP)

(72) Inventor: Hisashi Otaka, Toride-shi (JP)

(21) Appl. No.: 15/890,520

(22) Filed: Feb. 7, 2018

(30) Foreign Application Priority Data
Feb. 15, 2017 (JP) 2017-026171

(51) Int. Cl. H04N 1/04; G03G 15/04; H04N 1/00

(52) U.S. Cl. CPC H04N 1/0464; G03G 15/04072; H04N 2201/0082; H04N 1/00702; H04N 2201/0081; H04N 1/00687

(57) ABSTRACT

An image reading apparatus includes a sheet supporting portion configured to support a sheet, a sheet feeding portion configured to feed the sheet, a reading unit configured to read an image on the sheet, a body portion including a conveyance path configured to guide the sheet fed by the sheet feeding portion to the reading unit, a first detection unit including a first moving portion configured to be in contact with the sheet and move, and a first detection portion configured to detect the first moving portion, a second detection unit including a second moving portion configured to be in contact with the sheet and move, and a second detection portion configured to detect the second moving portion, and a support member supported detachably on the body portion, and configured to support the first and second detection portions.

### BACKGROUND OF THE INVENTION

### Field of the Invention

The present invention relates to an image reading apparatus for reading images on sheets, and an image forming apparatus equipped with the same.

### Description of the Related Art

In general, an image reading apparatus configured to automatically feed documents supported on a document tray and the like one by one and read image information from the document conveyed on a U-turn conveyance path is widely known. Hitherto, an image reading apparatus having a first sensor configured to detect whether a document has been set on a document tray and second to fourth sensors disposed along the U-turn conveyance path and configured to detect the position of the sheet conveyed on the U-turn conveyance path is proposed (refer to Japanese Patent Laid-Open No. 2010-239595). The first to fourth sensors are respectively composed of an optical sensor whose optical path may be blocked by a rotor pressed against and rotated by a sheet.

Recently, along with the increase of functions of image reading apparatuses, a plurality of sensors must be provided in each image reading apparatus, which leads to deterioration of maintenance performance of the apparatus, since these sensors must be removed for maintenance.

### SUMMARY OF THE INVENTION

According to a first aspect of the present invention, an image reading apparatus includes a sheet supporting portion configured to support a sheet, a sheet feeding portion configured to feed the sheet supported on the sheet supporting portion, a reading unit configured to read an image on the sheet fed by the sheet feeding portion, a body portion including a conveyance path configured to guide the sheet fed by the sheet feeding portion to the reading unit, a first detection unit including a first moving portion configured to be in contact with the sheet and move, and a first detection portion configured to detect the first moving portion, a second detection unit including a second moving portion configured to be in contact with the sheet and move, and a second detection portion configured to detect the second moving portion, and a support member supported detachably on the body portion, and configured to support the first and second detection portions.

According to a second aspect of the present invention, an image reading apparatus includes a sheet supporting portion configured to support a sheet, a sheet feeding portion configured to feed the sheet supported on the sheet supporting portion, a reading unit configured to read an image on the sheet fed by the sheet feeding portion, a body portion including a conveyance path configured to guide the sheet fed by the sheet feeding portion to the reading unit, a first detection portion configured to output a signal regarding a presence of the sheet supported on the sheet supporting portion from a first connector portion, a second detection portion configured to output a signal regarding a position of the sheet conveyed on the conveyance path from a second connector portion, and a support member supported detachably on the body portion, and configured to support the first and second detection portions.

According to a third aspect of the present invention, an image reading apparatus includes a sheet supporting portion configured to support a sheet, a sheet feeding portion configured to feed the sheet supported on the sheet supporting portion, a reading unit configured to read an image on the sheet fed by the sheet feeding portion, a body portion comprising a conveyance path configured to guide the sheet fed by the sheet feeding portion to the reading unit, a first detection unit comprising a first flag configured to be in contact with the sheet and move, and a first photosensor configured to detect the first flag, a second detection unit comprising a second flag configured to be in contact with the sheet and move, and a second photosensor configured to detect the second flag, a first support member configured to support the first and second photosensors and the second flag, and a second support member configured to support the first flag. The first flag is configured to be in contact with the sheet supported on the sheet supporting portion and move. The first detection unit detects a presence of the sheet supported on the sheet supporting portion based on a detection result of the first photosensor. The second flag is configured to be in contact with the sheet conveyed on the conveyance path and move. The second detection unit is configured to detect a position of the sheet conveyed on the conveyance path based on a detection result of the second photosensor.

Further features of the present invention will become apparent from the following description of exemplary embodiments with reference to the attached drawings.

### BRIEF DESCRIPTION OF THE DRAWINGS

FIG. 1A is an entire schematic view illustrating a printer according to a present embodiment.

FIG. 1B is a schematic view illustrating a configuration of an image forming engine.

FIG. 2 is a perspective view illustrating a printer.

FIG. 3 is an enlarged view illustrating a configuration of an ADF.

FIG. 4 is a perspective view illustrating an ADF in a state where an upper conveyance guide is removed.

FIG. 5 is a perspective view illustrating a sensor holder.

### DESCRIPTION OF THE EMBODIMENTS

### First Embodiment

### Entire Configuration

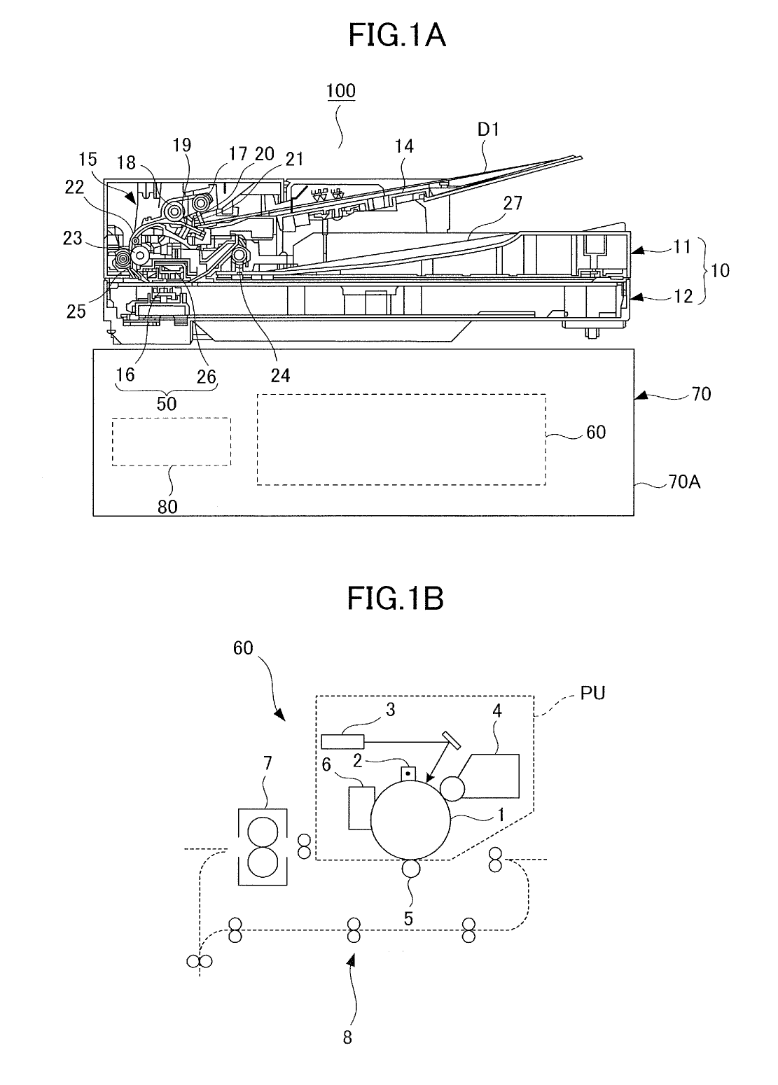

Now, a first embodiment of the present invention will be described. A printer 100 serving as an image forming apparatus according to the first embodiment is a laser beam printer adopting an electrophotographic system. As illustrated in FIG. 1A, the printer 100 includes a printer body 70, and an image reading portion 10 disposed above the printer body 70. In the following description, a sheet not only refers to normal paper, but also refers to special paper such as coated paper, recording material having a special shape such as an envelope or an index paper, a plastic film for overhead projectors, cloth and so on. The term sheet also refers to a document having an image printed on one side or on both sides, and a blank document that has no image printed on either side.

The printer body 70 includes an image forming engine 60 formed on in inner side of a casing 70A. The image forming engine 60 includes, as illustrated in FIG. 1B, an image forming unit PU adopting an electrophotographic system, and a fixing unit 7. When an image forming operation is instructed to be started, a photosensitive drum 1 serving as a photoconductor is rotated, and a surface of the drum is uniformly charged by a charging unit 2. Then, an exposing unit 3 modulates and outputs laser beams based on image data transmitted from the image reading portion 10 or an external computer to scan the surface of the photosensitive drum 1 and form an electrostatic latent image. The electrostatic latent image is visualized, i.e., developed, by toner supplied from a developing unit 4, and a toner image is formed.

Simultaneously as the image forming operation, a feeding operation of feeding the sheet supported on a cassette not shown or a manual feed tray toward the image forming engine 60 is performed. The sheet being fed is conveyed along with the advancement of the image forming operation by the image forming unit PU. Then, the toner image borne on the photosensitive drum 1 is transferred to a sheet by a transfer roller 5. The toner remaining on the photosensitive drum 1 after transferring the toner image is collected by a cleaning unit 6. The sheet to which an unfixed toner image has been transferred is delivered to the fixing unit 7, where the sheet is nipped by a roller pair, heated, and pressed. The sheet onto which the image has been fixed by having the toner melted is discharged through a sheet discharge roller pair to an exterior of the casing 70A. If duplex printing is to be performed, the sheet having passed the fixing unit 7 is reversed by a reverse conveyance portion 8 and conveyed again toward the image forming unit PU in the reversed state, and after having an image formed on a rear side of the sheet, the sheet is discharged to the exterior of the casing 70A.

Further, a control unit 80 is arranged in the printer body 70. The control unit 80 includes a central processing unit (CPU) that performs integrated control of the printer 100, and a memory storing programs executed by the CPU, image information, and setting information. The control unit 80 controls the image forming engine 60 to perform an image forming operation, and an image is formed on a recording medium.

The image forming engine 60 is an example of an image forming portion configured to form an image on a sheet serving as the recording medium, and it is possible to adopt an intermediate transfer system that includes an intermediate transfer member, or other mechanisms such as an ink-jet system, instead of the direct transfer system described above.

### Image Reading Portion

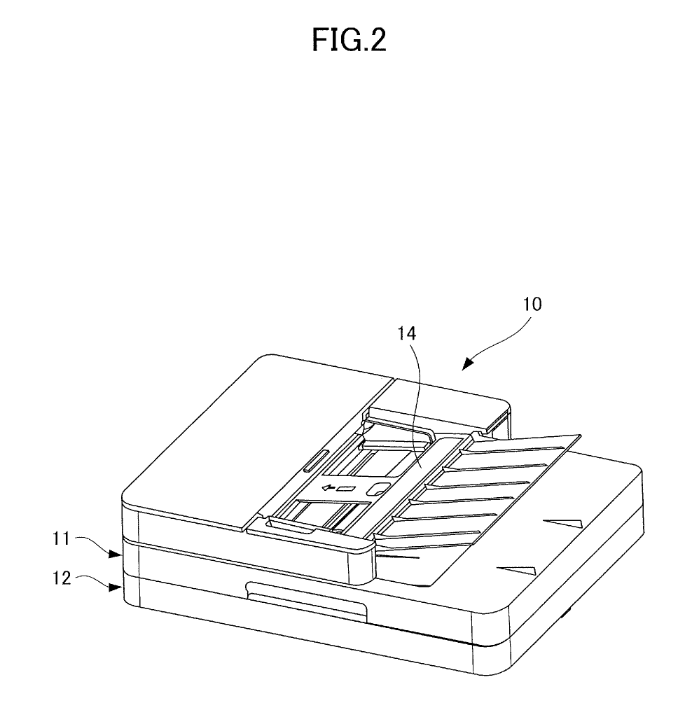

Next, the image reading portion 10, which is an example of an image reading apparatus, will be described. As illustrated in FIG. 2, the image reading portion 10 includes an ADF 11 for automatically feeding the document placed on a document tray 14, and a scanner portion 12 equipped with a platen glass. The ADF (Auto Document Feeder) 11 is supported pivotably on the scanner portion 12 by a hinge such that the platen glass can be exposed.

As illustrated in FIG. 1A, the ADF 11 includes a document tray 14 serving as a sheet supporting portion on which a document D1 is supported, a document conveyance portion 15 for conveying the document D1 supported on the document tray 14, and a sheet discharge tray 27 onto which the document D1 is discharged. The document conveyance portion 15 includes a conveyance path 22 curved approximately in a U-shape. A pickup roller 17, a separation roller 18, a separation pad 19, a document stopper 20, a document presence flag 21, a conveyance roller pair 23, a sheet discharge roller pair 24 and a document edge flag 25 are arranged along the conveyance path 22 in the document conveyance portion 15.

Reading sensors 16 and 26 configured to read image information from the document D1 are arranged respectively in the ADF 11 and the scanner portion 12. A contact type image sensor is used as the reading sensors 16 and 26. The reading sensors 16 and 26 are configured to irradiate light to an image information surface of the document D1 from an LED array serving as a light source, form an image on a sensor element by the light reflected from the image information surface and passed through a lens, and thereby read the image information. The reading sensors 16 and 26 compose a reading unit 50 serving as a reading unit for reading the image on the sheet.

Now, we will describe an operation of the image reading portion 10 to read image information from the document D1 while the ADF 11 feeds the document D1, in other words, a document feeding-reading operation. At first, an operator places the document D1 on the document tray 14. At this time, a leading edge position of the document D1 is regulated by the document stopper 20, and the document D1 is detected by the document presence flag 21 being pressed by the document D1, according to which the control unit 80 recognizes the presence of the document.

When the operator instructs to start the reading operation through an operation portion not shown, the document stopper 20 is pushed down by a driving force supplied from a driving unit not shown, and the document D1 is conveyed by the pickup roller 17 to a separation portion formed between the separation roller 18 and the separation pad 19. In this state, the document D1 is separated from the other documents by the separation pad 19, and an uppermost document D1 is conveyed by the separation roller 18. The separated document D1 is conveyed by the conveyance roller pair 23 along the conveyance path 22, and conveyed toward a reading position where the reading sensors 16 and 26 perform reading operation.

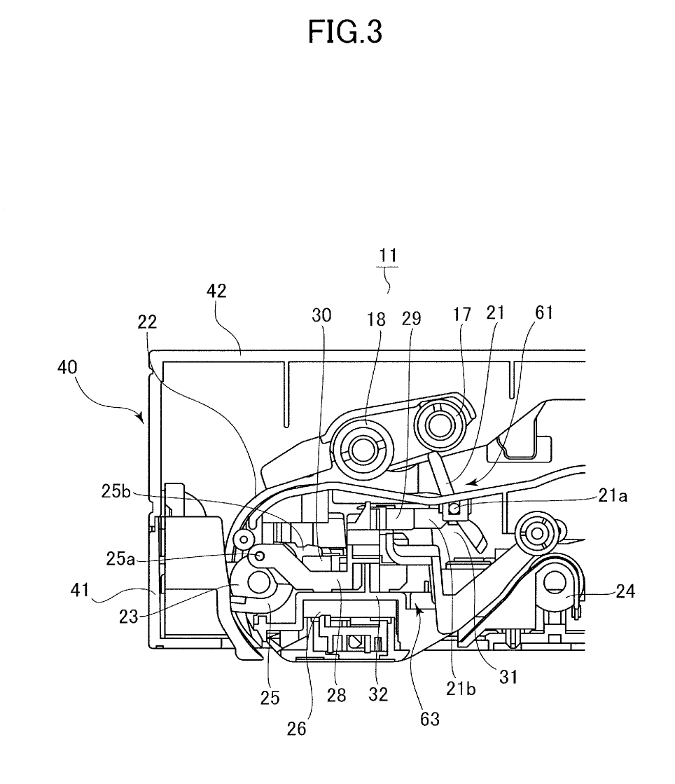

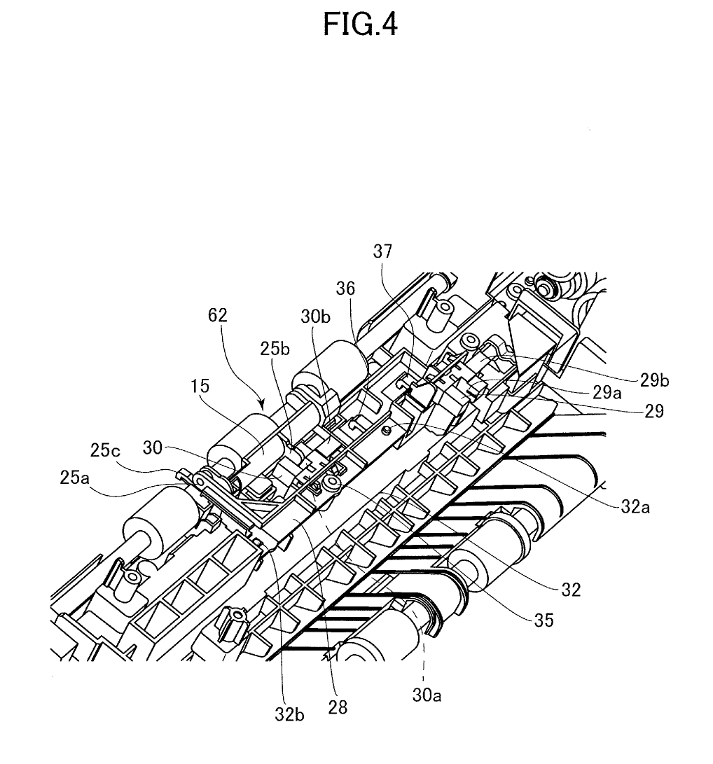

Thereafter, if a leading edge portion of the document D1 is detected by a document edge sensor 30 (refer to FIG. 4) described later, reading of the image information by the reading sensors 16 and 26 is started at a timing when the leading edge portion of the document D1 has been conveyed for a predetermined amount from the detection position of the document edge sensor 30. A reading sensor 16 serving as a first reading portion arranged on the scanner portion 12 reads the image information from a first side, i.e., front side, of the document D1. A reading sensor 26 serving as a second reading portion arranged on the ADF 11 reads the image information from a second side, i.e., rear side, opposite to the first side of the document D1. The document D1 having passed the reading position of the reading sensors 16 and 26 is conveyed toward the sheet discharge roller pair 24. When a trailing edge portion of the document D1 is detected by the document edge sensor 30 (refer to FIG. 4), the reading of image information by the reading sensors 16 and 26 is ended at a timing where the trailing edge portion of the document D1 has been conveyed for a predetermined amount from the detection position of the document edge sensor 30. Then, the document D1 is discharged by the sheet discharge roller pair 24 to the sheet discharge tray 27. Such reading operation is repeatedly performed until the document presence flag 21 and a document presence sensor 29 (refer to FIG. 3) described later detect that there is no document placed on the document tray 14.

The image reading portion 10 is configured to perform an operation to read image information from the document placed on the platen glass of the scanner portion 12, that is, a fixed reading operation. In that case, the image information is read from the document by the reading sensor 16 moving in a sub-scanning direction (right-left direction of FIG. 1A) along the platen glass in a state where the document is placed still on the platen glass.

### Configuration of Body Portion and Respective Sensors

Next, a configuration of a body portion 40 serving as a casing of the ADF 11 and the various sensors will be described with reference to FIGS. 3 and 4. The body portion 40 including the conveyance path 22 has, as illustrated in FIG. 3, a body frame 41, an opening/closing frame 42, an upper conveyance guide 31 serving as a second support member, and a lower conveyance guide 32. A hinge that supports the ADF 11 with respect to the scanner portion 12 is disposed on the body frame 41, and the opening/closing frame 42 is openably and closably supported on the body frame 41. When the opening/closing frame 42 is opened, the conveyance path 22 is exposed to an outside of the ADF 11. The upper conveyance guide 31 constitutes an upstream side in a sheet conveyance direction of the conveyance path 22, and the lower conveyance guide 32 serving as a base member is disposed below the upper conveyance guide 31 and constitutes a downstream side of the conveyance path 22 in the sheet conveyance direction. The upper and lower conveyance guides 31 and 32 constitute a guide unit 63.

As illustrated in FIG. 3, the upper conveyance guide 31 pivotably supports a pivot shaft 21a of the document presence flag 21, and the document presence flag serving as a first moving portion and a first flag includes a blocking portion 21b configured to block a detection portion 29a (refer to FIG. 4) of the document presence sensor 29. The document presence flag 21 is arranged to protrude to the conveyance path 22 in a standby state, and at this time, the blocking portion 21b blocks a detection portion 29a of the document presence sensor 29. If the document D1 is placed on the document tray 14 (refer to FIG. 1A), the document presence flag 21 is pressed by the document D1 and pivots about the pivot shaft 21a, by which the blocking portion 21b stops blocking the detection portion 29a of the document presence sensor 29. In other word, the document presence flag 21 being in contact with the sheet is moved by the sheet, so that the document presence sensor 29 serving as the first detection portion and the first photosensor turns from off to on. The document presence flag 21 and the document presence sensor 29 constitute a first detection unit 61.

When all the documents on the document tray 14 have been fed by the pickup roller 17 serving as the sheet feeding portion, and there is no more document on the document tray 14, the document presence sensor 29 turns from on to off. As illustrated in FIG. 4, the document presence sensor 29 outputs these on/off signals from a connector portion 29b serving as a first connector portion, and the on/off signal is sent to the control unit 80 through a bundle wire not shown. Based on such detection result of the document presence sensor 29, the presence or absence of the sheet supported on the document tray 14 is detected.

FIG. 4 is a perspective view of the ADF 11 in a state where the upper conveyance guide 31 is removed. As illustrated in FIG. 4, the lower conveyance guide 32 detachably supports a sensor holder 28. Specifically, the sensor holder 28 is fixed to the lower conveyance guide 32 by a fixing screw 35 in a state where the sensor holder is positioned by positioning portions 32a and 32b. The sensor holder 28 serving as a support member and a first support member is arranged above the reading sensor 26 in a state being fixed to the lower conveyance guide 32, as illustrated in FIG. 3. Thereby, the apparatus can be downsized. The document presence sensor 29, a document edge sensor 30 and a document edge flag 25 are attached to the sensor holder 28.

A document edge flag 25 serving as a second moving portion and a second flag is movably supported to the sensor holder 28 about a pivot shaft 25a, as illustrated in FIGS. 3 and 4, and the document edge flag 25 includes a blocking portion 25b configured to block a detection portion 30a of the document edge sensor 30, and a projecting portion 25c that can be projected to the conveyance path 22. The projecting portion 25c of the document edge flag 25 is arranged to project to the conveyance path 22 in the standby state, and in this state, the blocking portion 25b blocks the detection portion 30a of the document edge sensor 30. If the projecting portion 25c of the document edge flag 25 is pushed by the leading edge of the document D1 being conveyed, the document edge flag 25 pivots about the pivot shaft 25a, and the blocking portion 25b releases the blocked state of the detection portion 30a of the document edge sensor 30. In other words, in a state where the document edge flag 25 moves by being in contact with the sheet, the document edge sensor 30 serving as a second detection portion and a second photosensor is turned from off to on. The document edge flag 25 and the document edge sensor 30 constitute a second detection unit 62.

In a state where the trailing edge of the document D1 passes the document edge flag 25, the document edge flag 25 returns to the standby state, and the document edge sensor 30 is turned from on to off. The document edge sensor 30 outputs these on/off signals from a connector portion 30b serving as a second connector portion, and the on/off signals are sent to the control unit 80 through a bundle wire not shown. Based on the detection result of the document edge sensor 30, the position of the leading edge and the trailing edge of the document D1 conveyed on the conveyance path 22, in other words, the position of the document D1, is detected.

### Sensor Holder

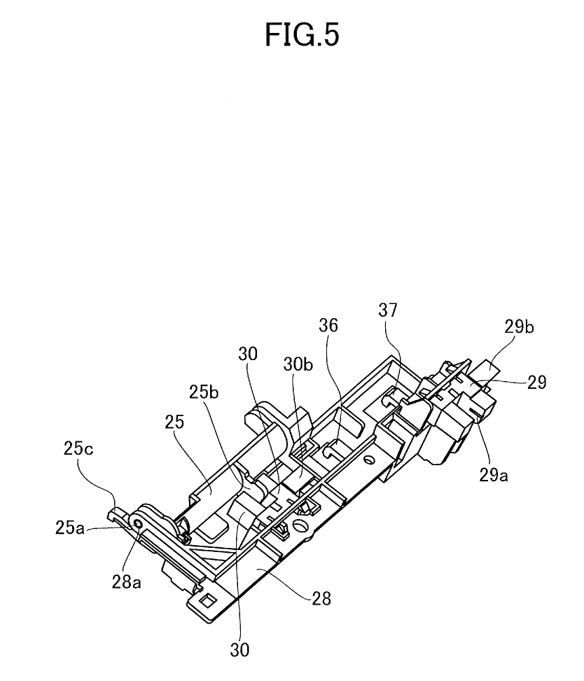

As described above, the sensor holder 28 can be removed easily from the lower conveyance guide 32, as illustrated in FIG. 5, by removing the fixing screw 35. Since the document presence sensor 29, the document edge sensor 30 and the document edge flag 25 are attached to the sensor holder 28, these sensors and flag can be removed simultaneously by simply removing the sensor holder 28, and the maintenance performance thereof can be improved.

More specifically, in order to remove the sensor holder 28, at first, bundle wires not shown connected to the connector portions 29b and 30b are removed from the connector portions 29b and 30b, and thereafter, the sensor holder 28 is removed from the lower conveyance guide 32. At this time, the bundle wire connected to the connector portion 30b is guided by the guide claws 36 and 37 toward a rear side of the ADF 11, but the bundle wire will not interfere while removing the sensor holder 28. Thus, both the document presence sensor 29 and the document edge sensor 30 can be removed simultaneously from the ADF 11 by simply removing the sensor holder 28, and there is no need to perform a wire bundling process, such that the maintenance property is improved.

Furthermore, since the document edge sensor 30 and the document edge flag 25 are attached to the same member, that is, the sensor holder 28, tolerance of components can be reduced, and the position of the document D1 can be detected highly accurately. Meanwhile, the document presence sensor 29 is supported on the sensor holder 28, and the document presence flag 21 is supported on the upper conveyance guide 31, such that the document presence sensor 29 and the document presence flag 21 are respectively attached to different members. However, since the document presence sensor 29 merely detects presence or absence of a document supported on the document tray 14, the detection accuracy of the document presence sensor 29 is maintained sufficiently.

In the present embodiment, the document presence sensor 29 and the document edge sensor 30 are respectively composed of a photosensing portion whose status of output is changed based on whether light emitted from a light emitting portion is detected by the detection portions 29a or 30a serving as a light receiving portion, but the configuration is not restricted thereto. In other words, the sensors are not restricted to optical sensors, and other sensors such as noncontact-type ultrasonic sensors or contact-type microswitches can be used. Further, the purpose of use of the sensors is not restricted to detecting presence and absence of the document or the position of the document. Regardless of the type of sensor being used, the sensor holder 28 is configured to support sensors having a bundled wire connected thereto.

According further to the present embodiment, the document presence sensor 29, the document edge sensor 30 and the document edge flag 25 are attached to the sensor holder 28, but the configuration is not restricted to such example, and for example, the document edge flag 25 can be attached to a different member. Further, the number of sensors and flags attached to the sensor holder 28 is not restricted to one or two, and can be three or more.

According further to the present embodiment, a configuration is adopted in which the document presence flag 21 and the document edge flag 25 are pivoted if pushed by the document, but the present embodiment is not restricted to this configuration. That is, a configuration can be adopted in which the document presence sensor 29 and the document edge sensor 30 are pivoted if pushed by the document, while the document presence flag 21 and the document edge flag 25 are fixed. Further, a configuration can be adopted in which the document presence flag 21 and the document edge flag 25 are moved in sliding motion, instead of pivoting.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-026171, filed Feb. 15, 2017, which is hereby incorporated by reference wherein in its entirety.

What is claimed is:

1. An image reading apparatus comprising:
a sheet supporting portion configured to support a sheet;
a sheet feeding portion configured to feed the sheet supported on the sheet supporting portion;
a reading unit configured to read an image on the sheet fed to a reading position by the sheet feeding portion;
a body portion comprising a conveyance path configured to guide the sheet fed by the sheet feeding portion to the reading position;
a first detection unit comprising a first moving portion configured to be in contact with the sheet and move, and a first detection portion configured to detect the first moving portion;
a second detection unit comprising a second moving portion configured to be in contact with the sheet and move, and a second detection portion configured to detect the second moving portion; and
a support member supported detachably on the body portion, and configured to support the first and second detection portions.

2. The image reading apparatus according to claim 1, wherein the first moving portion is supported movably on the body portion, and
the second moving portion is supported movably on the support member.

3. The image reading apparatus according to claim 1, wherein the first moving portion is configured to be in contact with the sheet supported on the sheet supporting portion and move,
the first detection unit is configured to detect a presence of the sheet supported on the sheet supporting portion based on a detection result of the first detection portion,
the second moving portion is configured to be in contact with the sheet conveyed on the conveyance path and move, and
the second detection unit is configured to detect the sheet conveyed on the conveyance path based on the detection result of the second detection portion.

4. The image reading apparatus according to claim 1, wherein the support member is a first support member,
the conveyance path is formed to be curved in a U-shape,
the body portion comprises a second support member configured to movably support the first moving portion and composing an upstream side of the conveyance path in a sheet conveyance direction, and a base member provided below the second support member and composing a downstream side of the conveyance path in the sheet conveyance direction, and
the first support member is configured to be supported detachably on the base member.

5. The image reading apparatus according to claim 1, wherein the reading unit comprises a first reading portion configured to read an image on a first side of the sheet, and a second reading portion configured to read an image on a second side opposite from the first side of the sheet, and
the support member is arranged above the second reading portion.

6. The image reading apparatus according to claim 1, wherein the first and second moving portions are respectively supported pivotably, and
the first and second detection portions are respectively photosensors.

7. An image reading apparatus comprising:
a sheet supporting portion configured to support a sheet;
a sheet feeding portion configured to feed the sheet supported on the sheet supporting portion;
a reading unit configured to read an image on the sheet fed to a reading position by the sheet feeding portion;
a body portion comprising a conveyance path configured to guide the sheet fed by the sheet feeding portion to the reading position;
a first detection portion comprising a first connector portion connected a bundle wire and configured to output a signal regarding a presence of the sheet supported on the sheet supporting portion from the first connector portion;
a second detection portion comprising a second connector portion connected a bundle wire and configured to output a signal regarding a position of the sheet conveyed on the conveyance path from the second connector portion; and
a support member supported detachably on the body portion, and configured to support the first and second detection portions.

8. The image reading apparatus according to claim 7, further comprising
a first moving portion configured to be in contact with the sheet supported on the sheet supporting portion and move, and be detected by the first detection portion, and
a second moving portion configured to be in contact with the sheet conveyed on the conveyance path and move, and be detected by the second detection portion.

9. The image reading apparatus according to claim 8, wherein the first moving portion is movably supported on the body portion, and
the second moving portion is movably supported on the support member.

10. An image reading apparatus comprising:
a sheet supporting portion configured to support a sheet;
a sheet feeding portion configured to feed the sheet supported on the sheet supporting portion;
a reading unit configured to read an image on the sheet fed to a reading position by the sheet feeding portion;
a body portion comprising a conveyance path configured to guide the sheet fed by the sheet feeding portion to the reading position;
a first detection unit comprising a first flag configured to be in contact with the sheet and pivot, and a first photosensor configured to detect the first flag;
a second detection unit comprising a second flag configured to be in contact with the sheet and pivot, and a second photosensor configured to detect the second flag;
a first support member configured to support the first and second photosensors and the second flag; and
a second support member configured to support the first flag,
wherein the first flag is configured to be in contact with the sheet supported on the sheet supporting portion and move,
the first detection unit detects a presence of the sheet supported on the sheet supporting portion based on a detection result of the first photosensor,
the second flag is configured to be in contact with the sheet conveyed on the conveyance path and move, and
the second detection unit is configured to detect a position of the sheet conveyed on the conveyance path based on a detection result of the second photosensor.

11. An image forming apparatus comprising:
the image reading apparatus according to claim 1; and
an image forming portion configured to form an image on a recording medium based on image information read by the image reading apparatus.

12. An image forming apparatus comprising:
the image reading apparatus according to claim 7; and
an image forming portion configured to form an image on a recording medium based on image information read by the image reading apparatus.

13. An image forming apparatus comprising:
the image reading apparatus according to claim 10; and
an image forming portion configured to form an image on a recording medium based on image information read by the image reading apparatus.
